(19) United States
(12) Patent Application Publication
(10) Pub. No.: US 2006/0000276 A1
(43) Pub. Date: Jan. 5, 2006

(54) Method of measuring amount of substances

(76) Inventors: Bran Ferren, Beverly Hills, CA (US); Nathan P. Myhrvold, Medina, WA (US); Clarence T. Tegreene, Bellevue, WA (US)

Correspondence Address: Searete LLC;Suite 110, 1756-114th Ave. S.E., Bellevue, WA, 98004, US

(21) Appl. No.: 10/883,929

(22) Filed: Jul. 2, 2004

(51) Int. Cl. G01N 29/04; G01F 1/66

(52) U.S. Cl. 73/290 V; 73/627

(57) ABSTRACT

A method and a system for determining a volume of a substance in a container where the method includes generating an excitation signal that creates an acoustic signal in the container, receiving the acoustic signal, and determining a volume of a substance in the container based at least in part on a signature of the acoustic signal.

### TECHNICAL FIELD

The present invention relates generally to techniques to determine amounts of substances in containers.

### SUMMARY

In one aspect, a method for determining a volume of a substance in a container includes: generating an excitation signal that creates an acoustic signal in the container, receiving the acoustic signal, and determining a volume of a substance in the container based at least in part on a signature of the acoustic signal.

In another aspect, a system for determining a volume of a substance in a container includes at least one excitation generator, at least one acoustic receiver, and an analytical instrument. The excitation generator is operable to generate an excitation signal that creates an acoustic signal in the container. The acoustic receiver is operable to receive the acoustic signal. The analytical instrument is operable to determine a volume of a substance in the container based at least in part on a signature of the acoustic signal.

In another aspect, an apparatus includes a container, an excitation generator, an acoustic receiver, and an analytical instrument. The excitation generator is operably coupled with the container. The acoustic receiver is operably coupled with the container and is operable to receive an acoustic signal. The analytical instrument is operably coupled with the acoustic receiver. The analytical instrument has a memory containing at least one signature of the acoustic signal in association with at least one corresponding volume of the substance in the container.

In another aspect, a differential method for determining a volume of a substance in a container includes the following steps. A first excitation signal is generated in a substance in a container. The first excitation signal creates a first acoustic signal in the container. The first acoustic signal is received, for example, with an acoustic receiver. A second excitation signal is generated either in a gas in the container or on a wall of the container. The second excitation signal creates a second acoustic signal in the container. The second acoustic signal is received, for example, with an acoustic receiver. A signature of the first acoustic signal is compared with a signature of the second acoustic signal to determine a volume of the substance in the container.

Implementations may include the following features. The acoustic receiver can be inside the container. The acoustic receiver can be coupled to a wall of the container. The acoustic receiver can be outside the container. The signature of the acoustic signal can include a spectrum of the acoustic signal. The signature of the acoustic signal can include one or more resonant frequencies in a spectrum of the acoustic signal.

In addition to the foregoing, various other method and/or system aspects are set forth and described in the text (e.g., claims and/or detailed description) and/or drawings of the present application.

The foregoing is a summary and thus contains, by necessity, simplifications, generalizations and omissions of detail; consequently, those skilled in the art will appreciate that the summary is illustrative only and is NOT intended to be in any way limiting. Other aspects, inventive features, and advantages of the devices and/or processes described herein, as defined by the claims, will become apparent in the detailed description set forth herein.

### BRIEF DESCRIPTION OF THE FIGURES

FIG. 1 and FIG. 2 show a system for determining an amount of liquid in a container.

FIG. 3 shows a method for determining an amount of liquid in a container.

FIG. 4 shows a differential method for determining a volume of a substance in a container.

### DETAILED DESCRIPTION

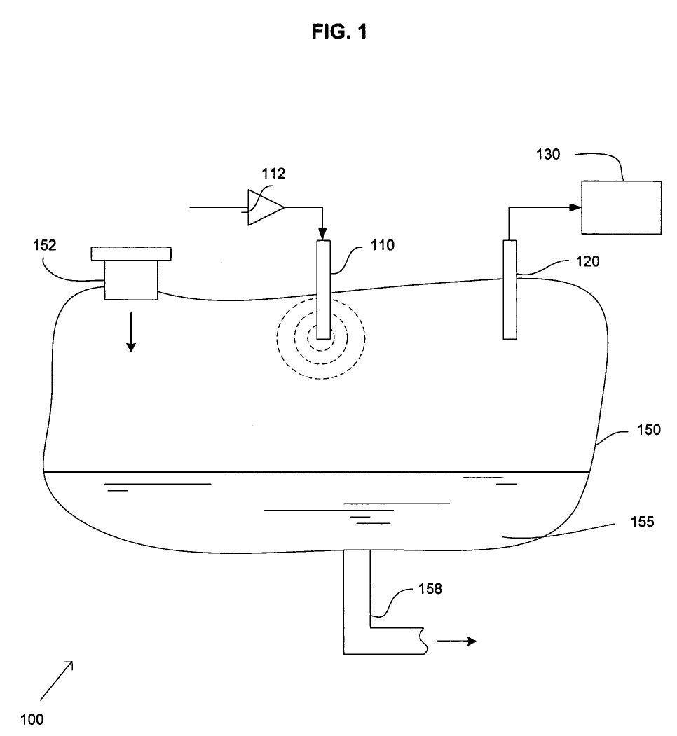

FIG. 1 shows a system 100 for determining an amount of liquid 155 in a container 150. Container 150 can have substantially any shape, such as solid rectangular, hollow ellipsoid sphere, or other kinds of regular shapes. Container 150 can also be irregular in shape. In one implementation, container 150 is a fuel tank. Container 150 can also include an inlet 152 or an outlet 158. Although the term “container” is used herein for sake of clarity, those skilled in the art will appreciate that the container 150 is meant to be representative of substantially any structure that may contain some volume of a substance. The container 150 can be, for example, an open container or an enclosed container. Some examples of container 150 include fuel tanks and/or coolant tanks and/or lubricant tanks of planes, automobiles, trains, ships, submarines, or other kinds of vehicles. Other specific examples of container 150 include fluid reservoirs and/or gel reservoirs and or other material (e.g., sand) reservoirs of industrial equipment (e.g., reservoirs used in refineries, chemical plants, and/or glass plants, etc.). Other specific examples of container 150 include rooms or other building storage areas wherein materials are kept (e.g., wafer storage facilities of semiconductor manufacturing plants). The general term “system” is used herein for sake of clarity, and those skilled in the art will appreciate that system 100 is meant to be representative of substantially any type system wherein container 150 may be utilized, such as planes, automobiles, trains, ships, submarines, military conveyances (e.g., tanks and/or helicopters), industrial facilities (e.g., petro-chemical refineries, chemical plants, nano-technology plants, and/or glass plants, etc.), and/or other systems wherein container 150 may be utilized.

System 100 generally includes an excitation generator 110, an acoustic receiver 120, and an analytical instrument 130. Excitation generator 110 can generate an excitation signal for creating an acoustic signal in container 150. Excitation generator 110 can be an acoustic generator (e.g., a speaker, or a spark generator), an accelerometer (e.g., a piezoelectric accelerometer, an electrodynamic accelerometer, a magnetostrictive accelerometer, or a capacitive accelerometer), or substantially any of other kinds of transducers consistent with the teachings herein. The acoustic signal in container 150 generally is received by acoustic receiver 120. The acoustic signal received by acoustic receiver 120 generally is sent to analytical instrument 130 for further signal processing. Analytical instrument 130 can use a signature of the acoustic signal to determine an amount of liquid 155 in container 150. Although the term “liquid” is used herein for sake of clarity, those skilled in the art will appreciate that liquid 155 is meant to be representative of substantially any substance that may be enclosed within a volume of space, such as fluids, gels, particulates (e.g., sand, or grains), solids (e.g., semiconductor wafers), etc. Liquid 155 is also meant to be representative of foods, plants, people, or other living stocks.

In one implementation, analytical instrument 130 is operable to compare a spectrum of the received acoustic signal with a list of spectra in a spectra look up table to determine the amount of liquid in container 150.

In another implementation, analytical instrument 130 is operable to find at least one resonant frequency in a spectrum of the received acoustic signal, and analytical instrument analytical instrument 130 is also operable to compare at least one resonant frequency in the spectrum of the received acoustic signal with a list of resonant frequencies in a frequency look up table to determine the amount of liquid in container 150. As an example of how to find the resonant frequencies, analytical instrument 130 can detect a frequency having a maximum strength in the spectrum of the acoustic signal, and designate the frequency having the maximum strength as one of the resonant frequencies.

Some of the implementations for determining the spectrum of the received acoustic signal and the resonant frequencies in the spectrum are described in the following.

In one implementation, excitation generator 110 generates a pulse excitation signal for creating the acoustic signal in container 150. Excitation generator 110 can also generate a chirp waveform signal. For determining the spectrum of the received acoustic signal or the resonant frequencies in that spectrum, analytical instrument 130 can transform the received acoustic signal into Fourier space. For example, analytical instrument 130 can digitize the acoustic signal received by the acoustic receiver and conduct a Fourier Transform on the digitized acoustic signal. Analytical instrument 130 can conduct a conventional Discrete Fourier Transform on the digitized acoustic signal or a Fast Fourier Transform on the digitized acoustic signal.

In another implementation, excitation generator 110 generates a substantially white noise excitation signal for creating the acoustic signal in container 150. Analytical instrument 130 can determine the resonant frequencies of container 150 from the received acoustic signal. A substantially white noise excitation signal includes excitation signals having spectra that are almost nearly flat in a frequency domain. A substantially white noise excitation signal can also include excitation signals having spectra that are not quite flat in a frequency domain.

In yet another implementation, excitation generator 110 generates a single frequency excitation signal for creating the acoustic signal in container 150 and sweeps the single frequency excitation from a first frequency to a second frequency. The resonant frequencies of container 150 between the first frequency and the second frequency can be determined by analytical instrument 130 using the received acoustic signal.

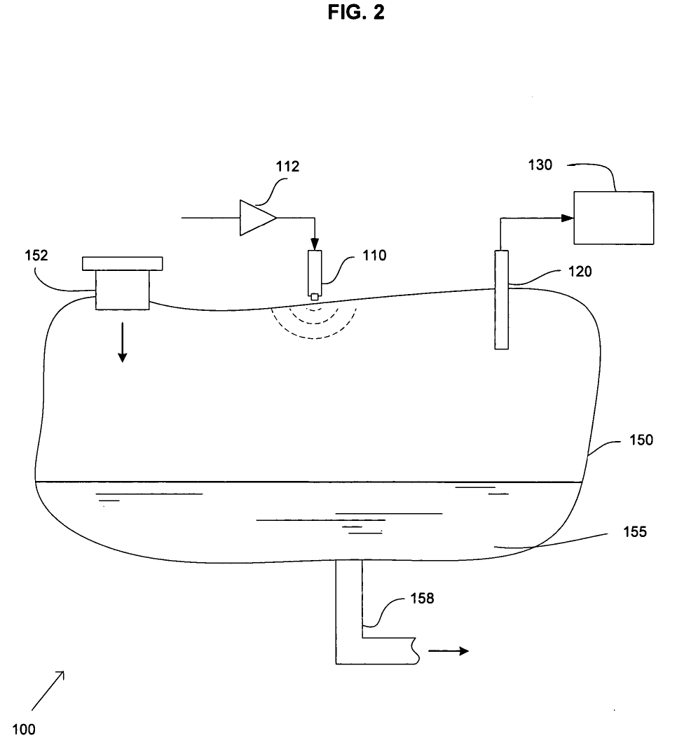

In an implementation as shown in FIG. 1, excitation generator 110 can generate an excitation signal interior to container 150 directly (e.g., by injecting energy into an interior of the container with an acoustic generator). In another implementation as shown in FIG. 2, excitation generator 110 can generate an excitation signal in container 150 by exciting a wall of container 150. Excitation generator 110 can include a transducer that makes contact on the outer wall of container 150 (as shown in FIG. 2). Excitation generator 110 can also include a transducer that makes contact on the inner wall of container 150. Excitation generator 110 can also include a transducer that injects energy directly into the interior of the container, where the transducer is not in contact with a wall of container 150. While the embodiment is described with the transducer in contact with the wall or interior, one skilled in the art will recognize that the transducer may couple energy to the inner wall, outer wall, or the interior indirectly. For example, the transducer may launch an acoustic wave a short distance from the inner wall, outer wall, or interior rather than through direct contact. Similarly, the transducer may couple energy indirectly, for example, by generating an acoustic wave in a material coupled directly or indirectly to the inner wall, outer wall, or interior.

In an implementation as shown in FIG. 1, acoustic receiver 120 is positioned interior to container 150. In other implementations, acoustic receiver 120 is positioned outside container 150. In other implementations, acoustic receiver 120 is positioned on or proximate to a wall of container 150.

Excitation generator 110 can receive an electrical signal from an electrical signal generator 112. Electrical signal generator 112 can generate a pulse electrical signal, a chirp waveform signal, a substantially white noise electrical signal, a substantially single frequency electrical signal, or other kinds of electrical signals.

Analytical instrument 130 can include an amplifier to amplify signals received from acoustic receiver 120. Analytical instrument 130 can also include an analog to digital converter for digitizing signals received from an output of the amplifier. The digitized signals can be sent to a Digital Signal Processor (DSP) for further processing. The Digital Signal Processor can perform filtering, windowing, Fourier transform, comparison, or other kinds of operations on the digitized signals.

Analytical instrument 130 can include a memory to store a signature of the acoustic signal in association with a corresponding volume of liquid 155 in container 150. In some implementations, a signature of an acoustic signal in association with a corresponding volume includes a frequency (e.g., 500 Hz) paired with a corresponding volume of a substance in container 150 (e.g., 30 cubic centimeters). The signature of the acoustic signal can include a spectrum of the acoustic signal, a resonant frequency in a spectrum of the acoustic signal, a collection of multiple resonant frequencies in a spectrum of the acoustic signal, or other detectable characteristics in the acoustic signal.

In some implementations, a display device can be used to display the volume of liquid 155 in container 150. One example of such a display device would include a fuel gauge of a vehicle. Other implementations may include displaying information graphical or textually at monitoring facility or on a portable device.

In an implementation as shown in FIG. 1, the volume of liquid 155 in container 150 may be determined with devices including excitation generator 110, acoustic receiver 120, and analytical instrument 130. In other implementations, other kinds of substances (e.g., gels, sands or other kinds of sand like materials) can be determined with similar techniques.

As specific examples, container 150 can be a fuel tank in a plane, an automobile, a train, a ship, a submarine, or other kind of vehicles.

Analytical instrument 130 can be implemented as a stand alone device. Analytical instrument 130 can also be implemented to include software and/or firmware and/or hardware on another computer system. For example, when container 150 is a fuel tank on an automobile and the automobile has an on-board computer, part of analytical instrument 130 can be implemented as software or firmware on the on-board computer.

In an implementation as shown in FIG. 1, excitation generator 110 is used to generate the excitation signal, and acoustic receiver 120 is used for receiving the acoustic signal induced by the excitation signal. In another implementation, excitation generator 110 and acoustic receiver 120 can be implemented as a single device (e.g., the same device can both excite and receive). In still another implementation, multiple acoustic receivers can be used for receiving the acoustic signal induced by the excitation signal. For example, in one implementation, multiple acoustic receivers are used to reject common mode background noise.

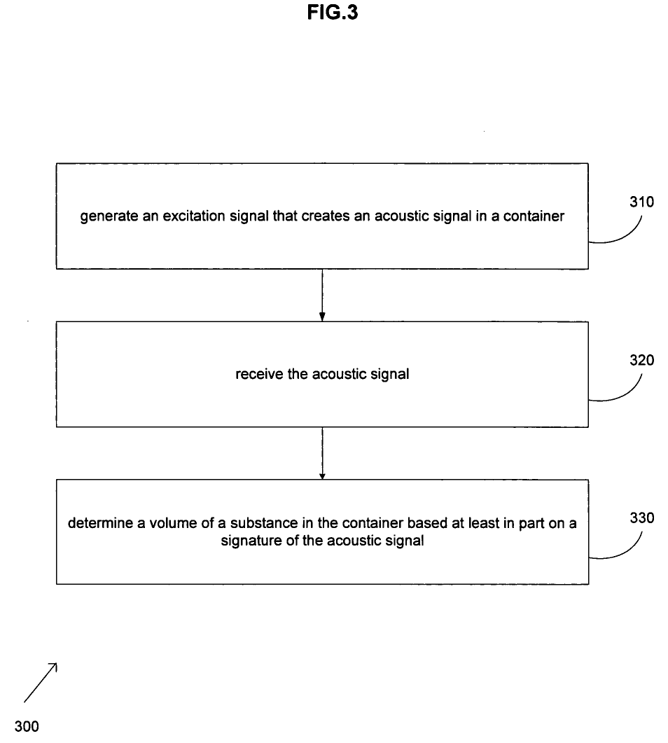

FIG. 3 generally shows a method 300 for determining a volume of a substance in a container. Method 300 includes steps 310, 320, and 330.

Step 310 illustrates generating an excitation signal that creates an acoustic signal in a container. In one implementation of step 310, such as shown and/or described in relation to FIG. 1, the excitation signal is generated with excitation generator 110. Excitation generator 110 can generate a pulse excitation signal, a substantially white noise excitation signal, a substantially single frequency excitation signal, or other kinds of excitation signals. Excitation generator 110 can generate an excitation signal in a gas in container 150, in liquid 155 in container 150, or on a wall of container 150. When a tube is connected to container 150, excitation generator 110 can also inject excitation energy into the tube connected to container 150.

Step 320 shows receiving the acoustic signal. In some implementations of step 320, such as shown and/or described in relation to FIG. 1, the acoustic signal is received with an acoustic receiver 120. In some implementations of step 330, a transducer of acoustic receiver 120 converts the acoustic signal to an electrical representation of the acoustic signal. In some implementations of step 330, an amplifier of acoustic receiver 120 amplifies the electrical representation of the acoustic signal to an electrical signal. In some implementations of step 330, an analog-to-digital converter of acoustic receiver 120 digitizes the electrical representation of the acoustic signal and delivers the digitized signal to analytical instrument 130.

Step 330 includes determining a volume of a substance in the container based at least in part on a signature of the acoustic signal. In one implementation, the amount of the substance in the container can be determined by comparing a spectrum of the received acoustic signal with one or more spectra in a spectra look up table. In another implementation, at least one resonant frequency in a spectrum of the received acoustic signal is determined, and amount of the substance in the container can be determined by comparing at least one resonant frequency in the spectrum of the received acoustic signal with one or more resonant frequencies in a frequency look up table. A resonant frequency in a spectrum of the received acoustic signal can be determined by detecting a frequency that has a maximum strength in the spectrum of the acoustic signal.

In some implementations of step 330, analytical instrument 130 receives a digitized version of an acoustic signal from the analog-to-digital converter of analytical instrument 130. In some implementations of step 330, upon receipt of the digitized version of the acoustic signal, logic of analytical instrument 130 executes a Fourier analysis to determine what frequency of the digitized signal has maximum strength (e.g., via program executing a Fast Fourier Transform on a processor of analytical instrument 130). In some implementations of step 330, logic of analytical instrument 130 designates the determined frequency of maximum strength as the resonant frequency. In some implementations of step 330, logic of analytical instrument 130 then compares the determined resonant frequency against a look up table that contains a list of frequencies in association with volumes of substance in container 150 to select a frequency of the table deemed most proximate to the determined resonant frequency (e.g., via comparison hardware and/or firmware). In some implementations of step 330, logic of analytical instrument 130 designates the volume associated with the selected frequency of the table (e.g., that most proximate to the resonant frequency) to be the volume of the substance in container 150.

Method 300 can also include additional steps. For example, method 300 can include recording a background acoustic signal. In one implementation, the recorded background acoustic signal is first subtracted from the acoustic signal received by the acoustic receiver to obtain a compensated acoustic signal. Then, the compensated acoustic signal is further processed to determine some signatures that can be used for determining a volume of a substance in a container.

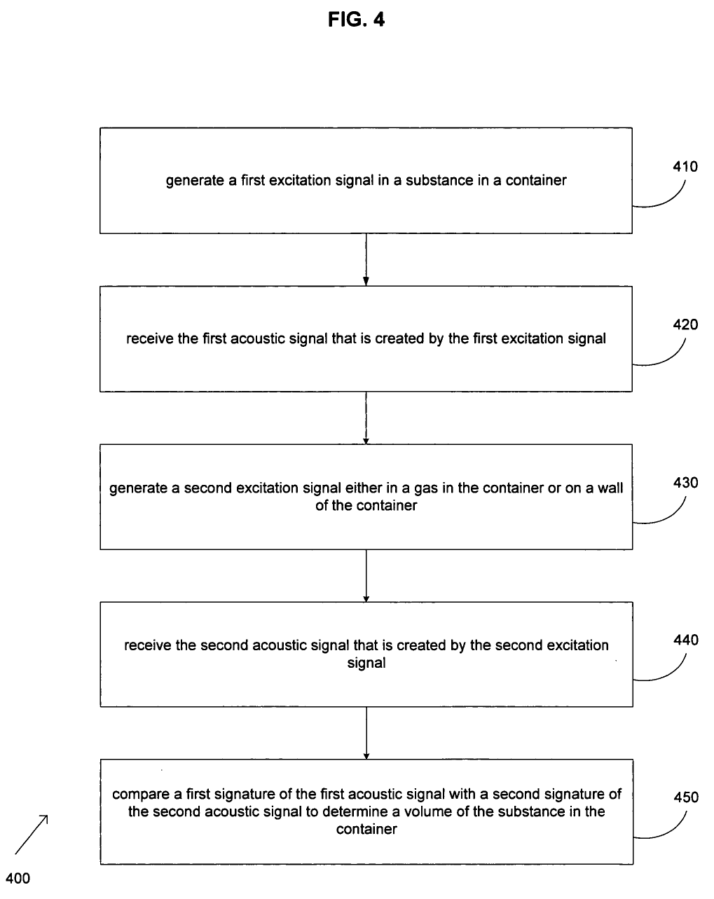

FIG. 4 generally shows a differential method 400 for determining a volume of a substance in a container. Method 400 includes steps 410, 420, 430, 440, and 450.

In step 410, a first excitation signal is generated in a substance in a container. The first excitation signal creates a first acoustic signal in the container. In step 420, the first acoustic signal is received, for example, with an acoustic receiver. In step 430, a second excitation signal is generated either in a gas in the container or on a wall of the container. The second excitation signal creates a second acoustic signal in the container. In step 440, the second acoustic signal is received, for example, with an acoustic receiver.

In step 450, a signature of the first acoustic signal is compared with a signature of the second acoustic signal to determine a volume of the substance in the container. The signature of the first acoustic signal can be a spectrum of the first acoustic signal, or one or more resonant frequencies in a spectrum of the first acoustic signal. Similarly, the signature of the second acoustic signal can be a spectrum of the second acoustic signal, or one or more resonant frequencies in a spectrum of the second acoustic signal.

In the above, methods and systems for determining a volume of a substance in a container are disclosed. The methods and systems disclosed herein can be implemented or modified to have one or more of the following applications. In one application, methods and systems disclosed herein can be used to determine how much diesel fuel is stored in a tank car, for example, under the condition that the diesel fuel may exhibit foaming or gas entrainment behavior. In another application, number of persons in a room can be determined based at least in part on a resonant frequency of the room, or other signatures of an acoustic signal. In another application, methods and systems disclosed herein can be used to determine a specific condition, such as, whether a volume of a substance stored in a container is above a threshold volume. In the implementation of FIG. 1, a specific condition can be determined by including a conditional filter in analytical instrument 130, and passing the acoustic signal received by acoustic receiver 120 through the conditional filter.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. In one embodiment, the subject matter described herein may be implemented via Application Specific Integrated Circuits (ASICs), Field Programmable Gate Arrays (FPGAs), or other integrated formats. However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter subject matter described herein are capable of being distributed as a program product in a variety of forms, and that an illustrative embodiment of the subject matter subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular aspects of the present subject matter described herein have been shown and described, it will be obvious to those skilled in the art that, based upon the teachings herein, changes and modifications may be made without departing from this subject matter described herein and its broader aspects and, therefore, the appended claims are to encompass within their scope all such changes and modifications as are within the true spirit and scope of this subject matter described herein. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of one having skill in the art would understand the convention (e.g., “a system having at least one of A, B, and C” would include but not be limited to systems that have A alone, B alone, C alone, A and B together, A and C together, B and C together, and/or A, B, and C together). In those instances where a convention analogous to “at least one of A, B, or C, etc.” is used, in general such a construction is intended in the sense of one having skill in the art would understand the convention (e.g., “a system having at least one of A, B, or C” would include but not be limited to systems that have A alone, B alone, C alone, A and B together, A and C together, B and C together, and/or A, B, and C together).

1. A method comprising:
generating an excitation signal that creates an acoustic signal in a container;
receiving the acoustic signal; and
determining a volume of a substance in the container based at least in part on a signature of the acoustic signal.

2. The method of claim 1 wherein the generating comprises:
generating an excitation signal that creates an acoustic signal in an enclosed container.

3. The method of claim 1 wherein the generating comprises:
generating an excitation signal that creates an acoustic signal in an open container;

4. The method of claim 1 wherein the generating comprises:
generating the excitation signal with an excitation generator;

5. The method of claim 4 wherein the excitation generator includes an acoustic generator.

6. The method of claim 4 wherein the excitation generator includes at least one of a piezoelectric accelerometer, an electrodynamic accelerometer, a magnetostrictive accelerometer, or a capacitive accelerometer.

7. The method of claim 4 wherein the excitation generator includes at least one transducer.

8. The method of claim 1 wherein the generating comprises:
exciting a wall of the container.

9. The method of claim 1 wherein the generating comprises:
exciting the substance in the container.

10. The method of claim 1 wherein the generating comprises:
exciting a gas in the container.

11. The method of claim 1 wherein the generating comprises:
injecting excitation energy into a tube connecting the container.

12. The method of claim 1 wherein the generating comprises:
generating a pulse excitation signal.

13. The method of claim 1 wherein the generating comprises:
generating a chirp waveform signal.

14. The method of claim 1 wherein the generating comprises:
generating a substantially white noise excitation signal.

15. The method of claim 1 wherein the generating comprises:
sequentially generating one or more excitation signals each having a center frequency.

16. The method of claim 15 wherein the sequentially generating further comprises:
sweeping the center frequency from a first frequency to a second frequency.

17. The method of claim 1 wherein the receiving comprises:
receiving the acoustic signal with an acoustic receiver.

18. The method of claim 1 wherein the receiving comprises:
receiving the acoustic signal with multiple acoustic receivers.

19. The method of claim 1 wherein the receiving comprises:
receiving at least a part of the acoustic signal at a location interior to the container.

20. The method of claim 1 wherein the receiving comprises:
receiving at least a part of the acoustic signal at a location proximate to or in contact with a wall of the container.

21. The method of claim 1 wherein the receiving comprises:
receiving at least a part of the acoustic signal at a location exterior to the container.

22. The method of claim 1 wherein the substance is liquid.

23. The method of claim 1 wherein the substance is a liquid that exhibits at least one of foaming behavior or gas entrainment.

24. The method of claim 1 wherein the substance is particulate matter.

25. The method of claim 1 wherein the substance is gel.

26. The method of claim 1 wherein the determining comprises:
storing the signature of the acoustic signal in a memory.

27. The method of claim 1 wherein the determining comprises:
comparing a spectrum of the acoustic signal with a list of spectra; and
determining the volume of the substance in the container in response to the comparing.

28. The method of claim 27 wherein the list of spectra is in a spectrum look up table.

29. The method of claim 1 wherein the determining comprises:
finding at least one resonant frequency in a spectrum of the acoustic signal; and
comparing the at least one resonant frequency in the spectrum of the acoustic signal with a list of one or more resonant frequencies having one or more respectively associated volumes.

30. The method of claim 29 wherein the list of one or more resonant frequencies is in a frequency look up table.

31. The method of claim 29 wherein the finding comprises:
detecting a frequency having a maximum strength in the spectrum of the acoustic signal.

32. The method of claim 1 wherein the determining comprises:
transforming the acoustic signal into Fourier space.

33. The method of claim 1 wherein the determining comprises:
digitizing the acoustic signal received by the acoustic receiver.

34. The method of claim 33 wherein the determining comprises:
conducting a Fourier Transform on the digitized acoustic signal.

35. The method of claim 33 wherein the determining comprises:
conducting a Fast Fourier Transform on the digitized acoustic signal.

36. The method of claim 1 further comprising:
recording a background acoustic signal.

37. The method of claim 36 wherein the determining comprises:
subtracting the background acoustic signal from the acoustic signal.

38. The method of claim 1 wherein the container is a room and the determining comprises:
determining a number of persons in the room based at least in part on a signature of the acoustic signal

39. The method of claim 38 wherein the determining comprises:
determining a number of persons in the room based at least in part on a resonant frequency of the room.

40. The method of claim 1 wherein the determining comprises:
passing the acoustic signal through a conditional filter to determine a specific condition.

41. The method of claim 40 wherein the specific condition is a condition that the volume of the substance is larger than a threshold volume.

42. The method of claim 40 wherein the specific condition is a condition that the volume of the substance is smaller than a threshold volume.

43. A system comprising:
means for generating an excitation signal that creates an acoustic signal in a container;
means for receiving the acoustic signal; and
means for determining a volume of a substance in the container based at least in part on a signature of the acoustic signal.

44. The system of claim 43 wherein the means for generating comprises an excitation generator.

45. The system of claim 44 wherein the excitation generator includes an acoustic generator.

46. The system of claim 44 wherein the excitation generator includes at least one transducer.

47. The system of claim 43 wherein the means for generating comprises:
means for exciting a wall of the container.

48. The system of claim 43 wherein the means for generating comprises:
means for exciting the substance in the container.

49. The system of claim 43 wherein the means for generating comprises:
means for exciting a gas in the container.

50. The system of claim 43 wherein the means for generating comprises:
means for generating a pulse excitation signal.

51. The system of claim 43 wherein the means for generating comprises:
means for generating a chirp waveform signal.

52. The system of claim 43 wherein the means for generating comprises:
means for generating a substantially white noise excitation signal.

53. The system of claim 43 wherein the means for generating comprises:
means for generating one or more excitation signals each having a center frequency.

54. The system of claim 43 wherein the means for generating comprises:
means for generating sequentially one or more excitation signals each having a center frequency.

55. The method of claim 54 wherein the means for generating sequentially further comprises:
means for sweeping the center frequency from a first frequency to a second frequency.

56. The system of claim 43 wherein the means for receiving comprises an acoustic receiver.

57. The system of claim 43 wherein the means for determining comprises:
means for storing the signature of the acoustic signal in a memory.

58. The system of claim 43 wherein the means for determining comprises:
means for comparing a spectrum of the acoustic signal with a list of spectra to determine the volume of the substance in the container.

59. The system of claim 58 wherein the list of spectra is in a spectrum look up table.

60. The system of claim 43 wherein the means for determining comprises:
means for finding at least one resonant frequency in a spectrum of the acoustic signal; and
means for comparing the at least one resonant frequency in the spectrum of the acoustic signal with a list of one or more resonant frequencies having one or more respectively associated volumes.

61. The system of claim 60 wherein the list of one or more resonant frequencies is in a frequency look up table.

62. The system of claim 60 wherein the means for finding comprises:
means for detecting a frequency having maximum strength in the spectrum of the acoustic signal.

63. The system of claim 43 wherein the means for determining comprises:
means for transforming the acoustic signal into Fourier space.

64. The system of claim 43 wherein the means for determining comprises:
means for digitizing the acoustic signal received by the acoustic receiver.

65. The system of claim 64 wherein the means for determining comprises:
means for conducting a Fourier Transform on the digitized acoustic signal.

66. The system of claim 64 wherein the means for determining comprises:
means for conducting a Fast Fourier Transform on the digitized acoustic signal.

67. A system comprising:
an excitation generator operable to generate an excitation signal that creates an acoustic signal in a container;
an acoustic receiver operable to receive the acoustic signal; and
an analytical instrument operable to determine a volume of a substance in the container based at least in part on a signature of the acoustic signal.

68. The system of claim 67 wherein the excitation generator includes an acoustic generator.

69. The system of claim 67 wherein the excitation generator includes at least one transducer.

70. The system of claim 69 wherein the excitation generator is operable to excite a wall of the container.

71. The system of claim 69 wherein the excitation generator is operable to excite the substance in the container.

72. The system of claim 69 wherein the excitation generator is operable to excite a gas in the container.

73. The system of claim 69 wherein the excitation generator and the acoustic receiver are integrated as a single device.

74. The system of claim 67 wherein the excitation generator is operable to generate a pulse excitation signal.

75. The system of claim 67 wherein the excitation generator is operable to generate a chirp waveform signal.

76. The system of claim 67 wherein the excitation generator is operable to generate a substantially white noise excitation signal.

77. The system of claim 67 wherein the excitation generator is operable to generate one or more excitation signals each having a center frequency.

78. The system of claim 67 wherein the excitation generator is operable to generate sequentially one or more excitation signals each having a center frequency.

79. The method of claim 78 wherein the excitation generator is operable to sweep the center frequency from a first frequency to a second frequency.

80. The system of claim 67 wherein the analytical instrument is operable to store the signature of the acoustic signal in a memory.

81. The system of claim 67 wherein the analytical instrument is operable to compare a spectrum of the acoustic signal with a list of spectra to determine the volume of the substance in the container.

82. The system of claim 81 wherein the list of spectra is in a spectrum look up table.

83. The system of claim 67 wherein:
the analytical instrument is operable to find at least one resonant frequency in a spectrum of the acoustic signal, and
the analytical instrument is also operable to compare the at least one resonant frequency in the spectrum of the acoustic signal with a list of one or more resonant frequencies having one or more respectively associated volumes.

84. The system of claim 83 wherein the list of one or more resonant frequencies is in a frequency look up table.

85. The system of claim 83 wherein:
the analytical instrument is operable to detect a frequency having maximum strength in the spectrum of the acoustic signal.

86. The system of claim 67 wherein the analytical instrument is operable to transform the received acoustic signal into Fourier space.

87. The system of claim 67 wherein the analytical instrument is operable to digitize the acoustic signal received by the acoustic receiver.

88. The system of claim 67 wherein the analytical instrument is operable to conduct a Fourier Transform on the digitized acoustic signal.

89. The system of claim 67 wherein the analytical instrument is operable to conduct a Fast Fourier Transform on the digitized acoustic signal.

90. The system of claim 67 wherein the analytical instrument comprises a conditional filter configured to determine a specific condition.

91. An apparatus comprising:
a container;
an excitation generator operably coupled with the container;
an acoustic receiver operably coupled with the container and operable to receive an acoustic signal; and
an analytical instrument operably coupled with the acoustic receiver, the analytical instrument having a memory containing at least one signature of the acoustic signal in association with at least one corresponding volume of the substance in the container.

92. The apparatus of claim 91 wherein the excitation generator includes an acoustic generator.

93. The apparatus of claim 91 wherein the excitation generator includes a transducer.

94. The apparatus of claim 91 wherein the excitation generator operably coupled to a wall of the container.

95. The apparatus of claim 91 wherein the acoustic receiver is inside the container.

96. The apparatus of claim 91 wherein the acoustic receiver is operably coupled to a wall of the container.

97. The apparatus of claim 91 wherein the acoustic receiver is outside the container.

98. The apparatus of claim 91 wherein the excitation generator and the acoustic receiver are integrated as a single device.

99. The apparatus of claim 91 further comprising:
an electrical signal generator operable to transmit a electrical signal to the excitation generator.

100. The apparatus of claim 99 wherein the signal generator includes an electrical output operable to transmit a pulse electrical signal to the excitation generator.

101. The apparatus of claim 99 wherein the signal generator includes an electrical output operable to transmit a substantially white noise electrical signal to the excitation generator.

102. The apparatus of claim 99 wherein the signal generator includes an electrical output operable to transmit one or more electrical signals each having a center frequency to the excitation generator.

103. The apparatus of claim 91 wherein the analytical instrument comprises:
an amplifier operably coupled with the acoustic receiver.

104. The apparatus of claim 103 wherein the analytical instrument comprises:
an analog to digital converter operably coupled with the amplifier and operable to generate digitized signals.

105. The apparatus of claim 104 wherein the analytical instrument comprises:
a Digital Signal Processor (DSP) operable to conduct Fourier transform on the digitized signals.

106. The apparatus of claim 91 wherein the at least one signature of the acoustic signal includes a spectrum of the acoustic signal.

107. The apparatus of claim 91 wherein the at least one signature of the acoustic signal includes one or more resonant frequencies in a spectrum of the acoustic signal.

108. The apparatus of claim 91 further comprising:
a display device configured to display the volume of the substance.
